(19) United States
(12) Patent Application Publication
(10) Pub. No.: US 2013/0077867 A1
(43) Pub. Date: Mar. 28, 2013

(54) IMAGE PROCESSING APPARATUS, IMAGE PROCESSING METHOD, AND METHOD OF CONTROLLING IMAGE PROCESSING APPARATUS

(71) Applicants: Koji Shoami, Tokyo (JP); Hisashi Ishikawa, Urayasu-shi (JP); Tadayuki Ito, Yokohama-shi (JP)

(72) Inventors: Koji Shoami, Tokyo (JP); Hisashi Ishikawa, Urayasu-shi (JP); Tadayuki Ito, Yokohama-shi (JP)

(73) Assignee: CANON KABUSHIKI KAISHA, Tokyo (JP)

(21) Appl. No.: 13/552,748

(22) Filed: Jul. 19, 2012

(30) Foreign Application Priority Data
Sep. 27, 2011 (JP) 2011-211599
May 7, 2012 (JP) 2012-106312

(51) Int. Cl. G06K 9/46

(52) U.S. Cl. CPC G06K 9/46
USPC 382/195

(57) ABSTRACT

When the processed pixel value is the last pixel value to be output for a unit region of interest, the apparatus stands by to output this pixel value until all pixels in the unit region of interest are input, and enables output of the pixel value on standby when all the pixels in the unit region of interest have been input.

### BACKGROUND

### Description of the Related Art

Conventionally, in an image processing module, a CPU sends a start signal to an input unit, the input unit inputs image data stored in a memory to an image processing unit in response to the start signal, and an output unit outputs processed data to a memory. After processing of a predetermined region ends, the output unit sends an end signal to the CPU. With this sequence, the image processing module performs image processing.

The above-mentioned image processing is normally performed for each predetermined region. Each predetermined region means herein, for example, a page, a band, or a block. The case wherein each predetermined region is a band (one band-shaped region obtained by dividing image data of one page into a plurality of regions in a band shape) will be described below.

FIG. 1 is a block diagram showing the schematic configuration of the above-mentioned image processing module. An input unit 101 inputs image data stored in a memory (not shown) to an image processing unit 102 for each band via a signal line 105. The image processing unit 102 performs, for each band, image processing for the data input from the input unit 101, and sends the processed data to an output unit 103 via a signal line 106. The output unit 103 sequentially outputs the processed data to a memory (not shown). After processing of one band ends, the output unit 103 sends an end signal to a CPU 104. This means that the output unit 103 must detect the end of processing of one band.

Hence, in the image processing unit 102, when the output data is the last output pixel in one band, band end identification information is added to it. This band end identification information will be referred to as an output band end signal hereinafter.

In the input unit 101 as well, when the output data is the last output pixel in one band, band end identification information is added to it. This band end identification information will be referred to as an input band end signal hereinafter.

When the output unit 103 receives an output band end signal from the image processing unit 102, it recognizes that image processing of one band has ended, and sends an end signal to the CPU 104. When the CPU 104 receives the end signal from the output unit 103, it determines that processing of one band has ended, and sends a start signal to the input unit 101 in order to start to process the next band. Upon receiving the start signal from the CPU 104, the input unit 101 inputs data of the next band from the memory to the image processing unit 102, and the image processing unit 102 starts to process the data of the next band. Subsequently, the above-mentioned image processing is repeated for each band, thereby performing predetermined image processing for image data of one page.

However, in the above-mentioned image processing, the image processing unit 102 may send an output band end signal to the output unit 103 before it receives an input band end signal from the input unit 101. When, for example, the latter half of an input image is cut in trimming processing, the above-mentioned output band end signal is added to the last pixel data (last output data) of the first half of the input image, and the obtained data is sent.

Therefore, before the input unit 101 ends data output of one band, the CPU 104 determines that processing of the current band has ended, and sends the above-mentioned start signal in order to start to process the next band, so the input unit 101 malfunctions. Also, when a plurality of image processing units are connected to each other in a necklace shape to have them perform pipeline processing, the same problem may occur in the course of processing by some of the image processing units. Especially in this case, the latency (amount of delay) is so long that the above-mentioned problem is more likely to occur.

### SUMMARY

The present disclosure has been made in consideration of the above-mentioned problem, and provides a technique for preventing a malfunction in processing an image for each specific unit region.

According to the first aspect of the present disclosure, an image processing apparatus comprising: an input unit that sequentially inputs pixel data included in partial image data; a processing unit that processes the pixel data input from the input unit, and outputs the processed pixel data; and an output control unit that outputs output pixel of interest data, which serves for synchronization with a latter block, of the processed pixel data as the input unit inputs input pixel of interest data included in the partial image data to the processing unit.

According to the second aspect of the present disclosure, an image processing apparatus comprising: an input unit that reads out for each specific unit region an image to be processed, and sequentially inputs pixels in the readout unit regions; and an image processing unit that processes an image in a unit region of interest using a pixel value of at least one pixel input via the input unit from the unit region of interest to determine a pixel value of each pixel in the image in the unit region of interest, and sequentially outputs the determined pixel values to a specific output destination, the image processing unit comprising: a processing unit that processes an input pixel value and determines the processed pixel value; a determination unit that determines whether the pixel value determined by the processing unit is a pixel value of a pixel of interest to be output for the unit region of interest; and a control unit that, when the determination unit determines that the pixel value determined by the processing unit is the pixel value of the pixel of interest to be output for the unit region of interest, stands by to output the determined pixel value until the input unit inputs all pixels in the unit region of interest, and enables output of the determined pixel value on standby after the input unit inputs all the pixels in the unit region of interest.

According to the third aspect of the present disclosure, a method of controlling an image processing apparatus including an input unit that sequentially inputs pixel data included in partial image data, and a processing unit that processes the pixel data input from the input unit, and outputs the processed pixel data, comprising: outputting output pixel of interest data, which serves for synchronization with a latter block, of the processed pixel data as the input unit inputs input pixel of interest data included in the partial image data to the processing unit.

According to the fourth aspect of the present disclosure, an image processing method executed by an image processing apparatus, comprising: an input step of reading out for each specific unit region an image to be processed, and sequentially inputting pixels in the readout unit regions; and an image processing step of processing an image in a unit region of interest using a pixel value of at least one pixel input in the input step from the unit region of interest to determine a pixel value of each pixel in the image in the unit region of interest, and sequentially outputting the determined pixel values to a specific output destination, the image processing step comprising: a processing step of processing an input pixel value and determining the processed pixel value; a determination step of determining whether the pixel value determined in the processing step is a pixel value of a pixel of interest to be output for the unit region of interest; and a control step of, when it is determined in the determination step that the pixel value determined in the processing step is the pixel value of the pixel of interest to be output for the unit region of interest, standing by to output the determined pixel value until all pixels in the unit region of interest are input in the input step, and enabling output of the determined pixel value on standby when all the pixels in the unit region of interest have been input in the input step.

Further features of the present disclosure will become apparent from the following description of exemplary embodiments with reference to the attached drawings.

### BRIEF DESCRIPTION OF THE DRAWINGS

FIG. 1 is a block diagram of the functional configuration of an image processing apparatus;

FIG. 2 is a block diagram of the functional configuration of an image processing unit 102;

FIG. 3 is a flowchart of processing by an output control unit 204;

FIG. 4 is a block diagram of the functional configuration of an output control unit 204;

FIG. 5 is a flowchart of processing by the output control unit 204;

FIG. 6 is a block diagram of the functional configuration of an image processing apparatus;

FIGS. 7A and 7B are block diagrams of the functional configurations of an image processing unit 650 and the image processing apparatus, respectively;

FIG. 8 is a block diagram of the functional configuration of an image processing circuit 706;

FIG. 9 is a flowchart of processing by an output control unit 804;

FIGS. 10A to 10D are overviews of the structures of data packets;

FIG. 11 is a block diagram of the functional configuration of an image processing unit 650; and

FIG. 12 is a block diagram of the functional configuration of an image processing circuit 706.

### DESCRIPTION OF THE EMBODIMENTS

Embodiments of the present invention will be described below with reference to the accompanying drawings. Note that the embodiments to be described hereinafter exemplify the case wherein the present invention is actually practiced, and provide one of practical examples of the configurations defined in the scope of claims.

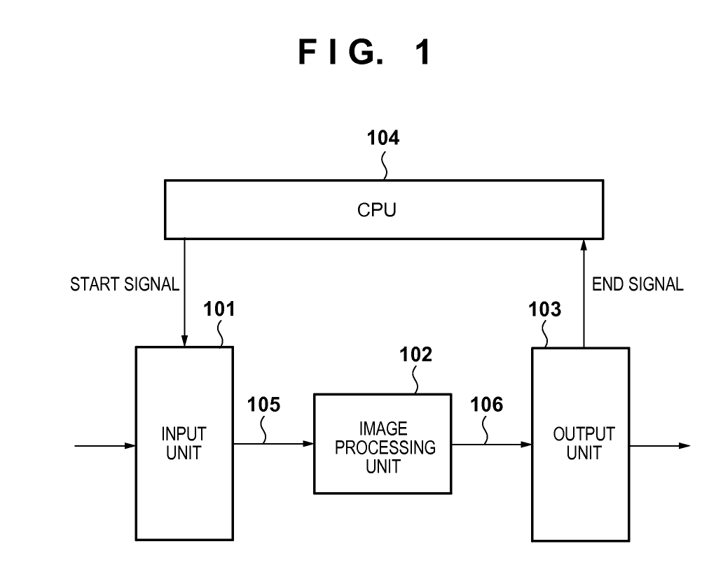

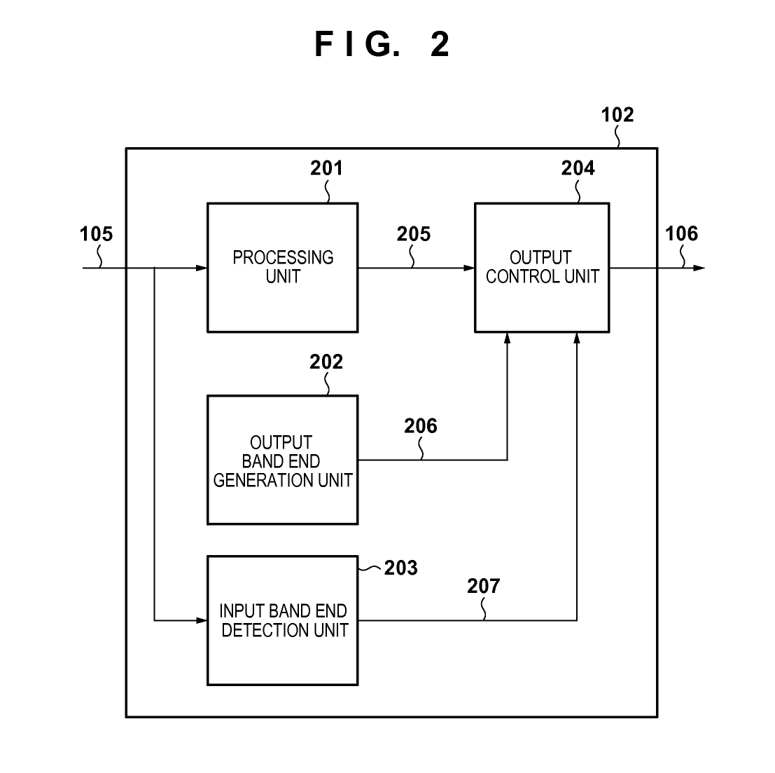

In one embodiment, the image processing apparatus according to this embodiment has a functional configuration illustrated in FIG. 1, and an image processing unit 102 has a configuration illustrated in FIG. 2. However, the configuration of the image processing apparatus is not limited to that shown in FIG. 1, and any configuration may be adopted as long as the image processing unit 102 having the functional configuration illustrated in FIG. 2 is applicable to this configuration.

An input unit 101 reads out, for each specific unit region, an image which is to be processed and is stored in a memory (not shown), and sequentially supplies pixel data (pixel values) in the readout unit regions to the image processing unit 102 via a signal line 105.

In this embodiment, the “specific unit region” is assumed to be the above-mentioned “band (band image)”. Hence, in this embodiment, the input unit 101 reads out, for each band, an image which is to be processed and is stored in a memory (not shown), and sequentially supplies pixel data (pixel values) in the readout bands to the image processing unit 102 via the signal line 105.

Also, in this embodiment, when the input unit 101 inputs each pixel in one band to the image processing unit 102, it refers to the positions from the upper left corner to the lower right corner in this band in the raster scan order, and inputs the pixel values of pixels at the referred positions to the image processing unit 102. However, the order of input of pixels to the image processing unit 102 is not limited to this.

When the input unit 101 sends the pixel value of each pixel in one band to the image processing unit 102, it stands by to receive a start signal from a CPU (processor) 104, and sends the pixel value of each pixel in the next band to the image processing unit 102 upon receiving the start signal. That is, the input unit 101 supplies the pixel value of each pixel in the next band to the image processing unit 102 every time it receives a start signal (it receives a readout instruction).

Note that the band means a partial image obtained by dividing an image in a strip shape in the sub-scanning direction. However, the specific unit region is not limited to the band, and one rectangular region obtained by simply dividing an image to be processed into a plurality of rectangular regions may be used as the “specific unit region”, or one region obtained by dividing an image to be processed using a certain division method may be used as the “specific unit region”.

Since the image processing unit 102 sequentially inputs, for each band, the pixel value of each pixel in this band from the input unit 101, it performs image processing for this band using the received pixel values to determine the pixel value of each pixel in this band. Note that depending on the processing details, the image processing unit 102 does not always determine the pixel value of each pixel in a band, input from the input unit 101, using the pixel values of all pixels in the band, but often determines the pixel value of each pixel in the band using the pixel value of at least one pixel. In other words, the image processing unit 102 processes an image in a unit region of interest using the pixel value of at least one pixel input via the input unit 101 from the unit region of interest thereby determining the pixel value for each pixel in the image.

The image processing unit 102 sends, for each band, the determined pixel value of each pixel in this band to an output unit 103 via a signal line 106. The image processing unit 102 will be described in more detail later.

When the output unit 103 receives the determined pixel value of each pixel in a band, which is sent for each band from the image processing unit 102, it sends this determined pixel value to an external equipment (for example, a memory (not shown) or an external device). Also, the output unit 103 sends an end signal to the CPU 104 every time it sends a group of determined pixel values for one band.

When the CPU 104 receives the end signal from the output unit 103, it reads out an image of the next band from the image which is to be processed and is stored in the above-mentioned memory, and sends to the input unit 101 a start signal for sequentially inputting pixels in the readout image to the image processing unit 102. Upon this operation, the input unit 101 reads out an image of the next band and sequentially supplies pixels in the readout image to the image processing unit 102, and the image processing unit 102 processes the image of the next band. In this way, the image processing unit 102 performs image processing for each band.

An example of the functional configuration of the image processing unit 102 will be described below with reference to a block diagram shown in FIG. 2. The operation of the image processing unit 102 when each pixel (each pixel value) in a band of interest is input from the input unit 101 to the image processing unit 102 via the signal line 105 will be described below. Note that the image processing unit 102 performs the following processing for each band.

Since the pixel value of each pixel in a band of interest is sequentially input to a processing unit 201, the processing unit 201 processes an image in the band of interest using the pixel value of at least one pixel in the band of interest to determine the pixel value of each pixel in the image. The processing unit 201 sequentially sends the determined pixel value of each pixel to an output control unit 204.

In this case, when the processing unit 201 performs trimming processing to cut the latter half of an input image, a band of interest output from the processing unit 201 becomes smaller than that input to the processing unit 201. Therefore, the timing at which “the processing unit 201 outputs the last pixel value of a band of interest” becomes earlier than that at which “the last pixel value of the band of interest is input to the processing unit 201”. When this happens, the end of processing may be determined at a timing earlier than that of the end of actual processing. The timing at which “the processing unit 201 outputs the last pixel value of a band of interest” will be referred to as an output timing hereinafter, and the timing at which “the last pixel value of the band of interest is input to the processing unit 201” will be referred to as an input timing hereinafter.

Processing in this embodiment will be briefly described below. First, an output band end generation unit 202 detects an output timing, and an input band end detection unit 203 detects an input timing. The output control unit 204 waits until “the pixel value of the last pixel in a band of interest is input to the processing unit 201” based on the detected output timing and input timing, and then controls to “output the pixel value of the last pixel in the band of interest processed by the processing unit 201”. Note that when the processing unit 201 performs image processing which uses different numbers of output pixels and input pixels, such as trimming, scaling processing, or filter processing, “the last pixel in a band of interest input to the processing unit 201” is made different from “the last pixel in the band of interest output from the processing unit 201”.

Operations by the output band end generation unit 202, input band end detection unit 203, and output control unit 204 will be described in detail below. An operation of detecting an output timing by the output band end generation unit 202 will be described first. The output band end generation unit 202 identifies whether the determined pixel value sent by the processing unit 201 is the last pixel (an output pixel of interest in this case) output for a band of pixel, that is, whether the processing unit 201 has output an output pixel of interest (output pixel of interest data).

This determination as to whether the processing unit 201 has output an output pixel of interest can be done in, for example, the following way. First, the processing unit 201 resets a counter to zero before the start of processing for a band of interest, and increments the counter value by one every time a determined pixel value is output from the processing unit 201. If the counter value has reached “the number of pixels in one band to be output”, the output band end generation unit 202 determines that “the processing unit 201 has output an output pixel of interest”. That is, if the counter value has reached “the number of pixels in one band to be output from the processing unit 201 upon trimming processing”, the output band end generation unit 202 determines that “the processing unit 201 has output the last pixel in one band to be output from the processing unit 201 upon trimming processing”. A method of determining whether the processing unit 201 has output an output pixel of interest is not limited to a specific method as described above, as a matter of course.

If the output band end generation unit 202 determines that “the processing unit 201 has output an output pixel of interest”, it sends an output band end signal to the output control unit 204 via a signal line 206. If the output band end generation unit 202 determines that “the processing unit 201 has not yet output an output pixel of interest”, it stands by to send an output band end signal.

An operation of detecting an input timing by the input band end detection unit 203 will be described next. If the input band end detection unit 203 detects that all pixels in a band of interest have been input to the processing unit 201 via the signal line 105, it sends an input band end signal to the output control unit 204 via a signal line 207. A detection method in this case is not limited to a specific method. Assume, for example, that the input unit 101 has added information (band end flag) indicating an input band end signal to the last pixel. In this case, if information indicating an input band end signal has been added to the last pixel input via the signal line 105, the input band end detection unit 203 determines that all pixels in a band of interest have been input to the processing unit 201 via the signal line 105.

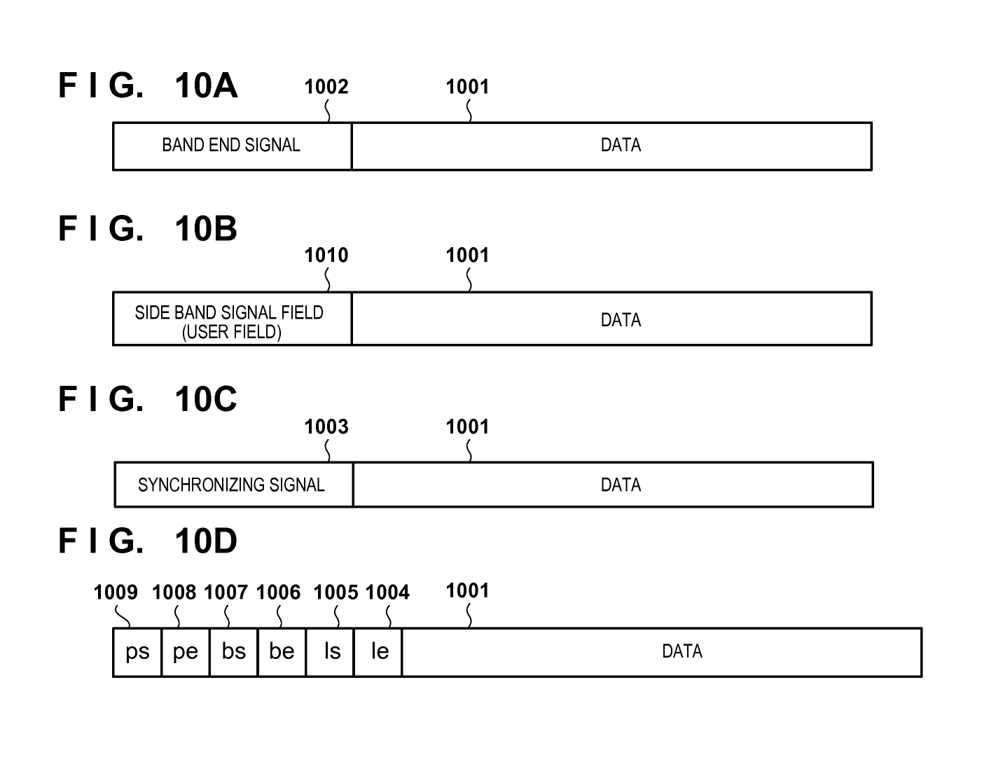

The operation of the output control unit 204 will be described next. The output control unit 204 sends intact the determined pixel value sent from the processing unit 201 to the output unit 103 via the signal line 106. The output control unit 204 continues this sending operation until it receives an output band end signal from the output band end generation unit 202. When the output control unit 204 receives the output band end signal from the output band end generation unit 202, it temporarily stops this sending operation. At this moment, the output control unit 204 has sent the pixel values of pixels other than an output pixel of interest but has not yet sent the output pixel of interest. The output control unit 204 then determines whether it has received an input band end signal from the input band end detection unit 203 at this moment. If the output control unit 204 determines that it has received an input band end signal at this moment, it sends an output pixel of interest to the output unit 103 via the signal line 106. On the other hand, if the output control unit 204 determines that it has not yet received an input band end signal at this moment, it holds an output pixel of interest until it receives an input band end signal, and sends the output pixel of interest to the output unit 103 via the signal line 106 upon receiving the input band end signal. That is, if the pixel value to be output next is the last pixel value to be output for a band of interest, the output control unit 204 stands by to output the last pixel value until all pixels in the band of interest are input, and enables output of the pixel value on standby when all the pixels have been input. This standby/enabling may be controlled by the output control unit 204 or a control unit (not shown). In either case, the output control unit 204 adds information indicating an output band end signal to an output pixel of interest and sends it. The information indicating an output band end signal is added to pixel data. FIG. 10A is a view illustrating an example of the structure of a data packet in this embodiment. A field 1001 stores data to be processed. A field 1002 stores an output band end signal indicating whether the pixel value of a pixel sent by the processing unit 201 is that of the last pixel.

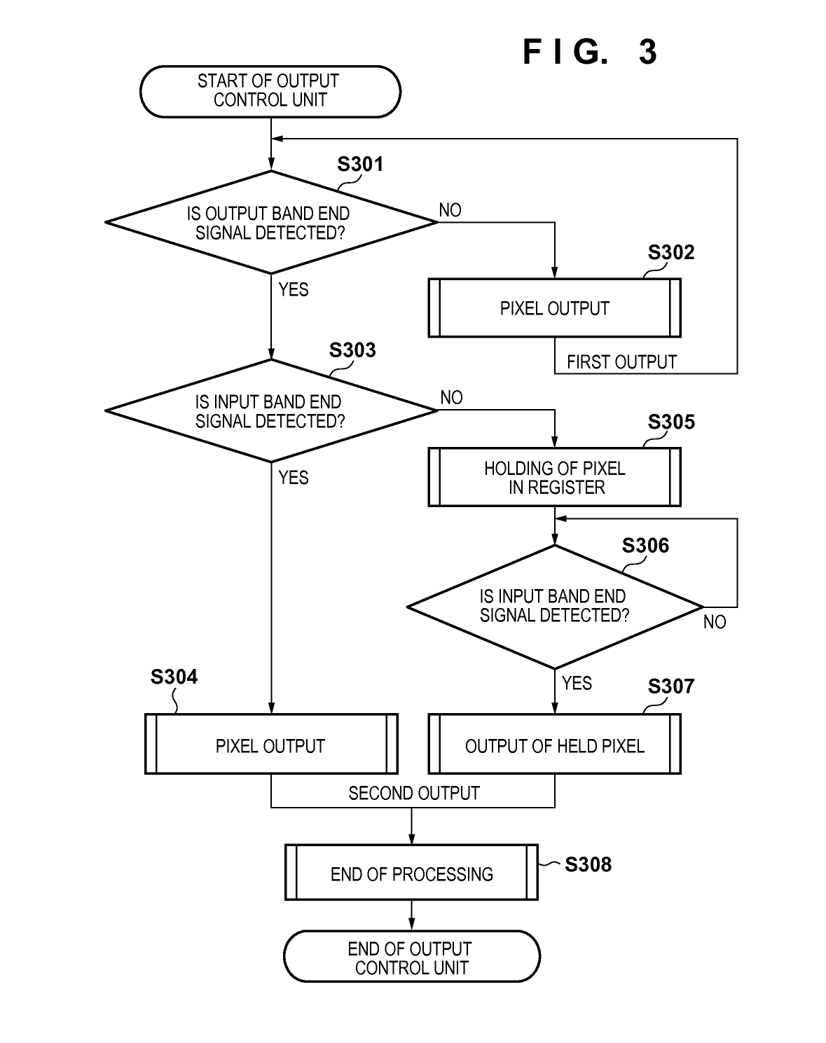

Processing by the output control unit 204 will be described below with reference to a flowchart shown in FIG. 3.

In step S301, the output control unit 204 determines whether it has received an output band end signal from the output band end generation unit 202 via the signal line 206. If NO is determined in step S301, the process advances to step S302; otherwise, the process advances to step S303.

In step S302, the output control unit 204 sends, to the output unit 103 serving as a specific output destination via the signal line 106, the pixel value of a pixel determined to be sent from the processing unit 201 (first output).

In step S303, the output control unit 204 determines whether it has received an input band end signal from the input band end detection unit 203. If NO is determined in step S303, the process advances to step S305; otherwise, the process advances to step S304. In step S304, the output control unit 204 sends an output pixel of interest to the output unit 103 serving as a specific output destination via the signal line 106 (second output).

In step S305, the output control unit 204 stores an output pixel of interest in the image processing unit 102 or a memory (register) in the image processing apparatus. In step S306, the output control unit 204 determines whether it has received an input band end signal from the input band end detection unit 203. If NO is determined in step S306, the process returns to step S306; otherwise, the process advances to step S307.

In step S307, the output control unit 204 sends the output pixel of interest stored in the memory in step S305 to the output unit 103 via the signal line 106 (second output). In step S308, the output control unit 204 performs appropriate end processing.

As described above, according to this embodiment, an output pixel of interest is held until an input band end signal is detected, and is output after the input band end signal is detected. This prevents an output band end signal from being output before an input band end signal is received. It is therefore possible to continuously perform image processing for each band without a malfunction.

In another embodiment, an output control unit 204 exchanges data by employing the known two-line handshake that uses a valid signal and a stall signal.

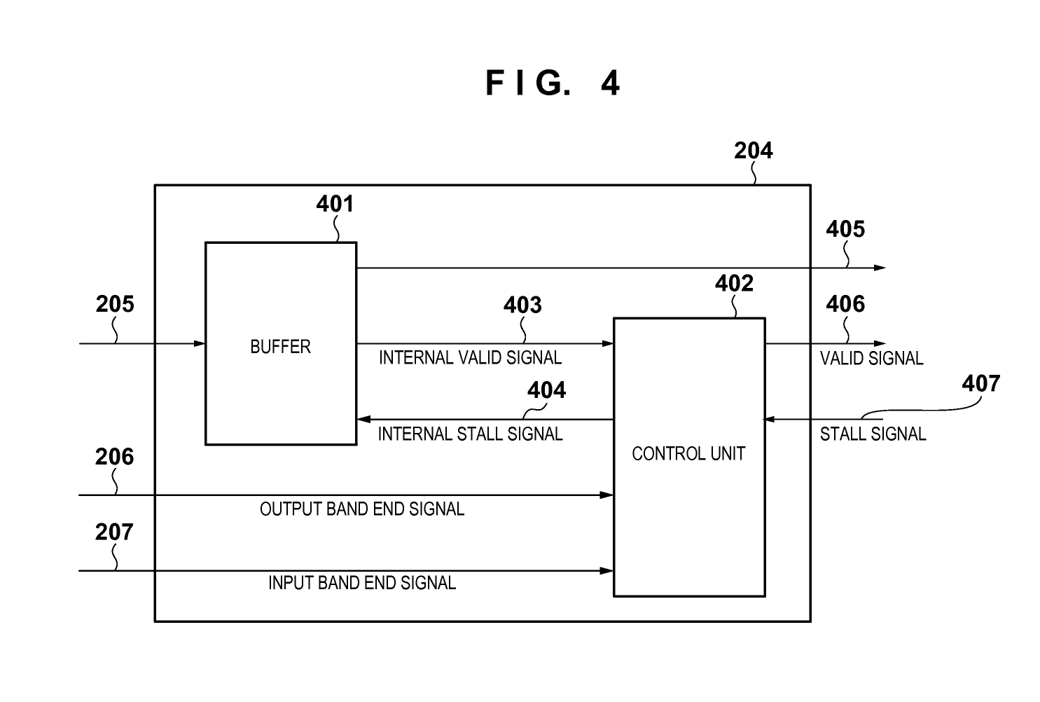

FIG. 4 illustrates an example of the functional configuration of the output control unit 204 according to this embodiment.

An internal valid signal (a signal line 403), an internal stall signal (a signal line 404), a valid signal (a signal line 406), and a stall signal (a signal line 407) shown in FIG. 4 will be described first.

The internal valid signal is to be sent by a buffer 401 to a control unit 402 via the signal line 403, and indicates whether the pixel value of a pixel determined to be output to the buffer 401 (to be simply referred to as a determined pixel value hereinafter) has been stored. For example, if a determined pixel value has not yet been stored in the buffer 401, the buffer 401 sends internal valid signal “0” to the control unit 402 via the signal line 403.

On the other hand, if a determined pixel value is stored in the buffer 401, the buffer 401 sends internal valid signal “1” to the control unit 402 via the signal line 403 to notify it of information indicating that the determined pixel value has been stored.

The internal stall signal is to be sent by the control unit 402 to the buffer 401 via the signal line 404, and indicates whether the buffer 401 is to stop outputting data. For example, if the control unit 402 has sent internal stall signal “1” to the buffer 401, it is determined that the control unit 402 has issued a request to stop outputting data, so the buffer 401 stops outputting data. On the other hand, if the control unit 402 has sent internal stall signal “0” to the buffer 401, it is determined that the control unit 402 has issued no request to stop outputting data, so the buffer 401 continues outputting data.

The stall signal is to be sent by an output unit 103 in the succeeding (or latter) stage to the control unit 402 via the signal line 407, and indicates whether the output unit 103 in the succeeding stage can accept data. For example, if the output unit 103 can accept data, it sends stall signal “0”; otherwise, it sends stall signal “1”.

The valid signal is to be sent by the control unit 402 to the output unit 103 in the succeeding stage via the signal line 406, and indicates whether the data output from the output control unit 204 is valid. For example, if the data output from the output control unit 204 is valid, the control unit 402 sends valid signal “1” to the output unit 103. On the other hand, if the data output from the output control unit 204 is invalid, the control unit 402 sends valid signal “0” to the output unit 103.

An output band end signal to be sent by an output band end generation unit 202 to the control unit 402 via a signal line 206, and an input band end signal to be sent by an input band end detection unit 203 to the control unit 402 via a signal line 207 will be described below. Note that signals will be briefly described hereinafter with reference to corresponding signal lines denoted by reference numerals.

In this embodiment, the output band end generation unit 202 and input band end detection unit 203 always send the output band end signal (signal line 206) and input band end signal (signal line 207), respectively. If a processing unit 201 has output an output pixel of interest, the output band end generation unit 202 sends an output band end signal (signal line 206) having a valid value (=1). On the other hand, if the processing unit 201 has not yet output an output pixel of interest, the output band end generation unit 202 sends an output band end signal (signal line 206) having an invalid value (=0). If the input band end detection unit 203 detects that all pixels in a band of interest have been input to the processing unit 201 via a signal line 105, it outputs an input band end signal having a valid value (=1). On the other hand, if the input band end detection unit 203 does not detect that all pixels in a band of interest have been input to the processing unit 201 via the signal line 105, the input band end detection unit 203 outputs an input band end signal having an invalid value (=0). More specifically, in a configuration which defines a low voltage as an invalid value in positive logic, the voltage of a signal line may be set to zero in issuing an invalid value, but a signal indicating an invalid value upon setting this voltage to zero is assumed to be output for the sake of simplicity.

The buffer 401 will be described below. A determined pixel value 205 of each pixel in a band of interest is input from the processing unit 201 to the buffer 401 and stored in the buffer 401.

The control unit 402 will be described below. The control unit 402 controls the value of the internal stall signal (signal line 404) to be sent to the buffer 401, and that of the output valid signal (signal line 406) to be sent to the output unit 103, in accordance with the value of the output band end signal (signal line 206), that of the input band end signal (signal line 207), and that of the stall signal (signal line 407). For example, when the output band end signal (signal line 206) has a valid value (=1) and the input band end signal (signal line 207) has an invalid value (=0), the control unit 402 sends a valid value (=1) to the buffer 401 as the internal stall signal (signal line 404). In this case, the control unit 402 also sends an invalid value (=0) to the output unit 103 as the valid signal (signal line 406).

Upon receiving a valid value (=1) as the internal stall signal (signal line 404), the buffer 401 stops outputting pixel values held in itself. In contrast, upon receiving an invalid value (=0) as the valid signal (signal line 406), the output unit 103 ignores sending from the buffer 401 (it does not latch data sent via the signal line).

On the other hand, if the output band end signal has an invalid value (=0), the control unit 402 transfers the stall signal (signal line 407) to the buffer 401 as the internal stall signal (signal line 404). The control unit 402 sends the internal valid signal (signal line 403) to the output unit 103 as the valid signal (signal line 406).

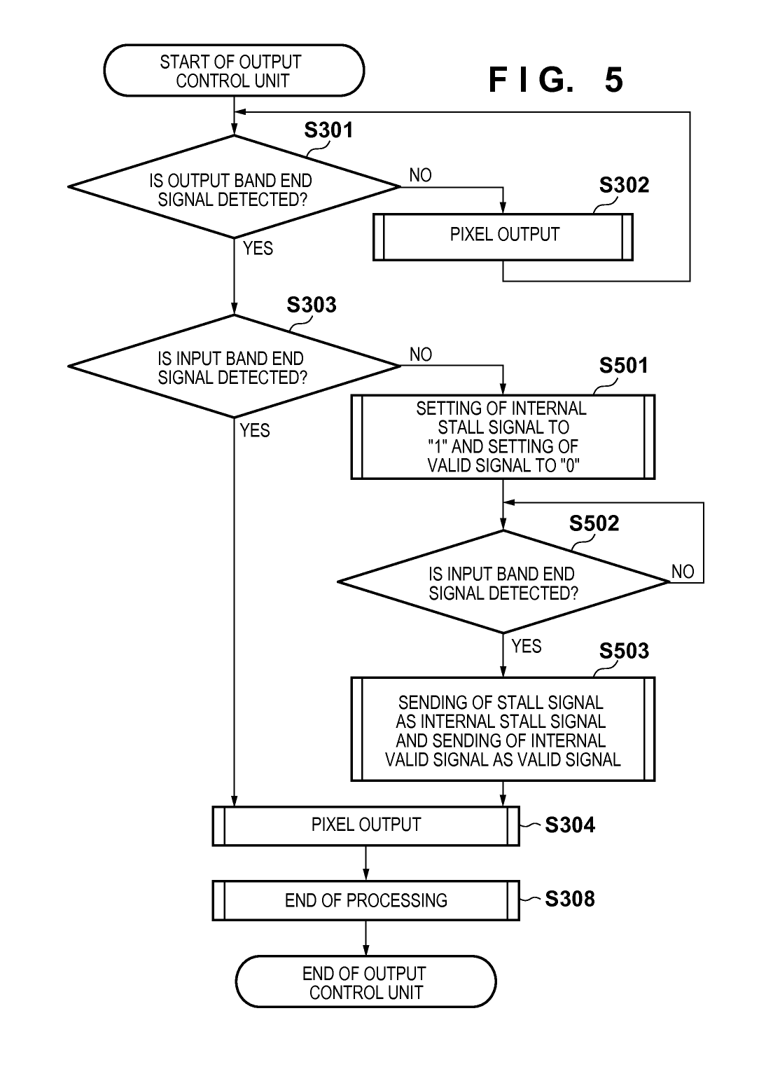

Processing by the output control unit 204 according to this embodiment will be described with reference to a flowchart shown in FIG. 5. Note that the control unit 402 in the output control unit 204 actually performs the processing of the flowchart shown in FIG. 5. Also, the same reference numerals as in the processing shown in FIG. 3 denote steps in which the same details are implemented in the processing shown in FIG. 5, and a description thereof will not be given.

Note that processing in step S302 is basically the same as mentioned above. However, in this embodiment, the control unit 402 transfers the stall signal (signal line 407) to the buffer 401 as the internal stall signal (signal line 404), and sends the internal valid signal (signal line 403) to the output unit 103 as the valid signal (signal line 406). This implements the same processing as in step S302 described above.

In step S501, the control unit 402 sends a valid value (=1) to the buffer 401 as the internal stall signal (signal line 404), and sends an invalid value (=0) to the output unit 103 as the valid signal (signal line 406).

In step S502, the control unit 402 determines whether it has received an input band end signal (signal line 207) having a valid value (=1). If NO is determined in step S502, the process returns to step S502; otherwise, the process advances to step S503.

In step S503, the control unit 402 transfers the stall signal (signal line 407) to the buffer 401 as the internal stall signal (signal line 404). The control unit 402 also sends the internal valid signal (signal line 403) to the output unit 103 as the valid signal (signal line 406). Upon this operation, pixel values can be output from the buffer 401 using the same procedure as in the two-line handshake.

As described above, according to this embodiment, the output control unit 204 of the image processing unit 102 performs handshake control with the output unit 103 in the succeeding stage, so an output pixel of interest is held until an input band end signal is detected, and is output after the input band end signal is detected. This prevents an output band end signal from being output before an input band end signal is received. It is therefore possible to continuously perform image processing for each band without a malfunction. Also, a register for holding a pixel if no input band end signal can be detected need not be added separately from a configuration which holds a determined pixel value. Note that band end signals have been taken as an example in the above-mentioned embodiments, the present disclosure is not limited to this, and is applicable as long as signals which require synchronization are used.

In another embodiment, output from an image processing circuit is controlled for an intermediate specific region or specific pixel (to be referred to as a pixel of interest hereinafter) in a band of interest in this embodiment. Note that in this embodiment, the same processing as in the input band end and output band end determination operations in the above mentioned embodiments are performed in a plurality of stages. A synchronizing signal output from the preceding stage is defined as an input pixel of interest (input pixel of interest data), and that output from the current stage is defined as an output pixel of interest.

In outputting an intermediate output pixel of interest in a band of interest to the succeeding block, an image processing unit 102 outputs a synchronizing signal to the succeeding block. This synchronizing signal serves to synchronize input/output of data in a unit region (band) between image processing circuits, and corresponds to information of interest for determining whether the pixel value output from the image processing unit 102 is that of a pixel of interest.

For example, if the synchronizing signal is “1” indicating a valid value, the data sent from the image processing unit 102 is the pixel value of an output pixel of interest in a band of interest. If the synchronizing signal is “0” indicating an invalid value, the data sent from the image processing unit 102 is not the pixel value of an output pixel of interest in a band of interest. The image processing unit 102 controls data output based on the synchronizing signal.

This makes it possible to synchronize input/output of an intermediate pixel other than the last pixel in a band between the circuits in the image processing unit 102, thereby continuously performing image processing without a malfunction. This embodiment will be described in more detail below.

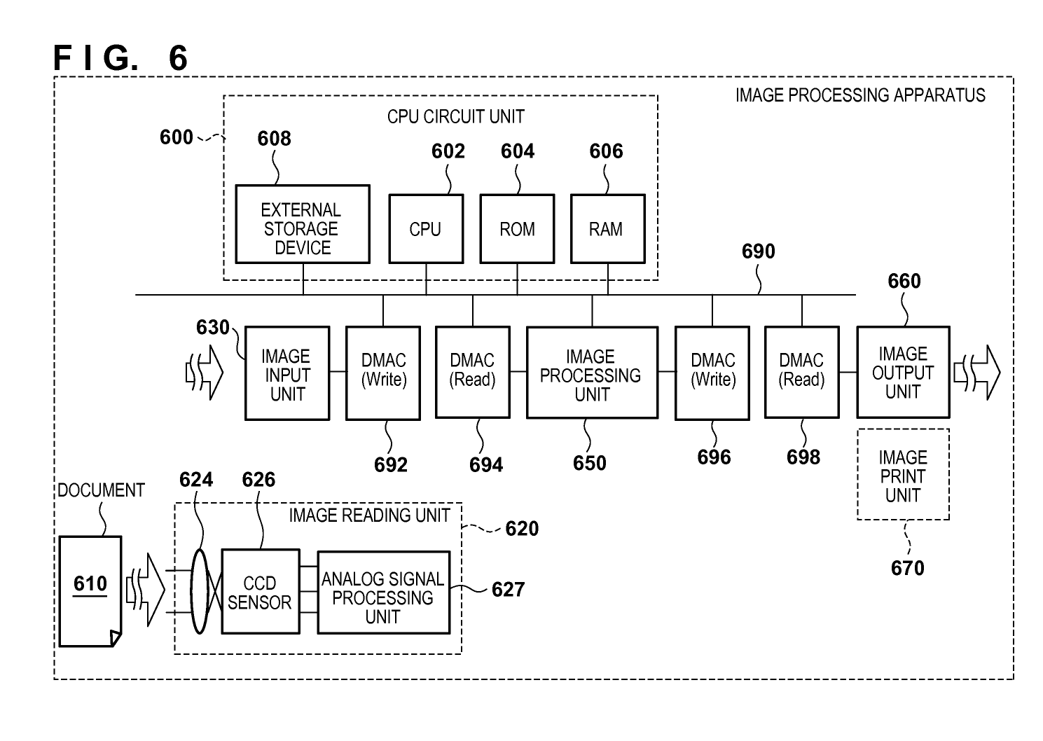

FIG. 6 is a block diagram of an image processing apparatus, for explaining this embodiment. Referring to FIG. 6, a CPU circuit unit 600 includes, for example, a CPU 602 for arithmetic control, a ROM 604 that stores fixed data and programs, a RAM 606 used to temporarily store data and load programs, and an external storage device 608. The CPU circuit unit 600 controls, for example, an image input unit 630, an image processing unit 650, and an image output unit 660, and systematically controls the sequence of the image processing apparatus in this embodiment. Note that the external storage device 608 is a storage medium such as a disk that stores parameters, programs, and correction data to be used by the image processing apparatus in this embodiment, and data and programs to be input to the RAM 606, for example, may be loaded from the external storage device 608.

The image input unit 630 has a configuration capable of inputting image data, and includes, for example, a configuration which inputs a captured image via a cable or that which downloads image data via, for example, the Internet. In the following description, an image reading unit 620 which reads a document 610 to generate image data will be taken as an example of the image input unit 630. The image reading unit 620 includes, for example, a lens 624, CCD sensor 626, and analog signal processing unit 627. The image reading unit 620 images the image information of the document 610 on the CCD sensor 626 via the lens 624 to convert it into an analog electrical signal having R (Red), G (Green), and B (Blue) components. The image information converted into an analog electrical signal is input to the analog signal processing unit 627, undergoes, for example, correction for respective colors: R, G, and B, and is analog/digital-converted (A/D-converted). This generates a digital full-color signal (digital image signal).

The digital image signal generated by the image reading unit 620 is stored in the RAM 606 of the CPU circuit unit 600 via a common bus 690 by a DMAC (Direct Memory Access Controller) 692, the operation of which is set in advance. Note that the CPU 602 controls the DMAC 692.

The CPU 602 controls a DMAC 694 to read the digital image signal stored in the RAM 606 and input it to the image processing unit 650. The image processing unit 650 corrects individual differences among reading elements of a sensor device such as a scanner and performs color correction such as input gamma correction for the input digital image signal to normalize the read image, thereby generating a digital image signal with a predetermined level. The CPU 602 stores the processed digital image signal in the RAM 606 again using a DMAC 696, the write operation of which is set in advance.

The image processing unit 650 also performs various types of image processing for printing, such as input color correction processing, spatial filter processing, color space conversion processing, density correction processing, and halftone processing, for the input digital image signal to generate a printable digital image signal. The generated, printable digital image signal is stored in the RAM 606 by the DMAC 696 as well. Then, the CPU 602 controls a DMAC 698 to read the processed digital image signal stored in the RAM 606, and outputs it to an image print unit 670. The image print unit 670 is implemented as a printer including a print output unit (not shown) such as a raster plotter which uses, for example, an inkjet head or a thermal head, and forms an image based on the input digital image signal on a printing sheet.

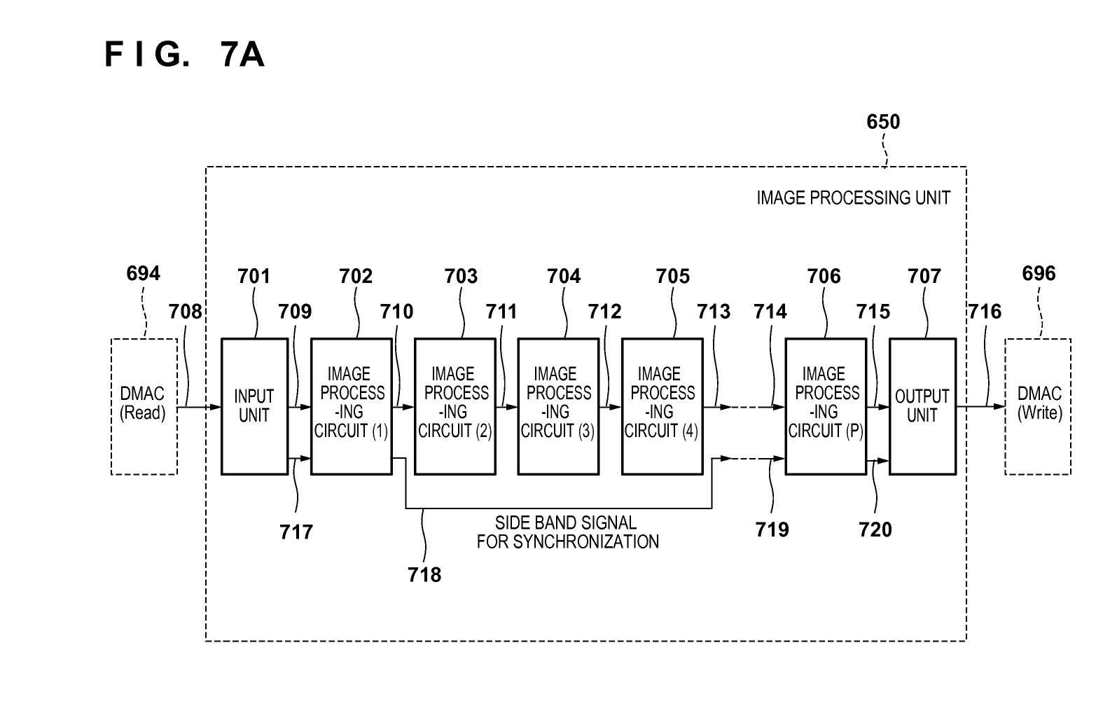

FIG. 7A illustrates an example of the main circuit configuration of the image processing unit 650 in this embodiment. Note that P (P is an integer of 2 or more) image processing circuits are present, and signal lines 708 to 716 are data signal lines for sending the pixel values of pixels of a digital image signal to succeeding blocks. Signal lines 717 to 720 are side band signals for sending synchronizing signals to succeeding blocks. Each pixel value of a digital image signal will be simply referred to as a pixel value hereinafter.

An input unit 701 receives a pixel value from the DMAC 694. The input unit 701 sends the pixel value input from the DMAC 694 to an image processing circuit 702. The input unit 701 also sends a synchronizing signal to the image processing circuit.

The pixel value sent from the input unit 701 is sent to a series of image processing circuits 702 to 706, and undergoes various types of correction processing or image processing.

An output unit 707 sends the corrected pixel value (determined pixel value or processed pixel data) to the DMAC 696, and the DMAC 696 rewrites the corrected pixel value (determined pixel value) into the RAM 606.

The series of image processing circuits (image processing modules) 702 to 706 perform individual types of image processing such as input color correction processing, spatial filter processing, color space conversion processing, density correction processing, and halftone processing. Each of the image processing circuits 702 to 706 may perform, for example, processing for one color (one plane) or processing for a set of several colors: R, G, and B or C, M, Y, and K.

In this embodiment, image processing is sequentially performed for each band (one band-shaped region obtained by dividing image data of one page into a plurality of regions in a band shape).

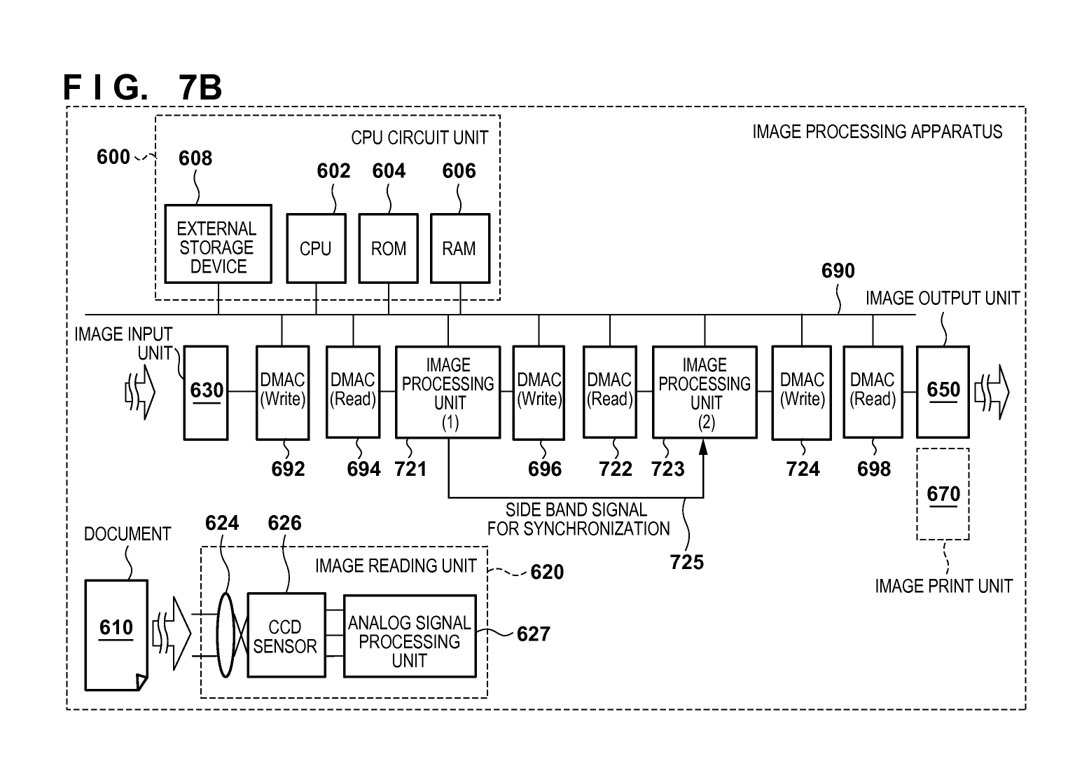

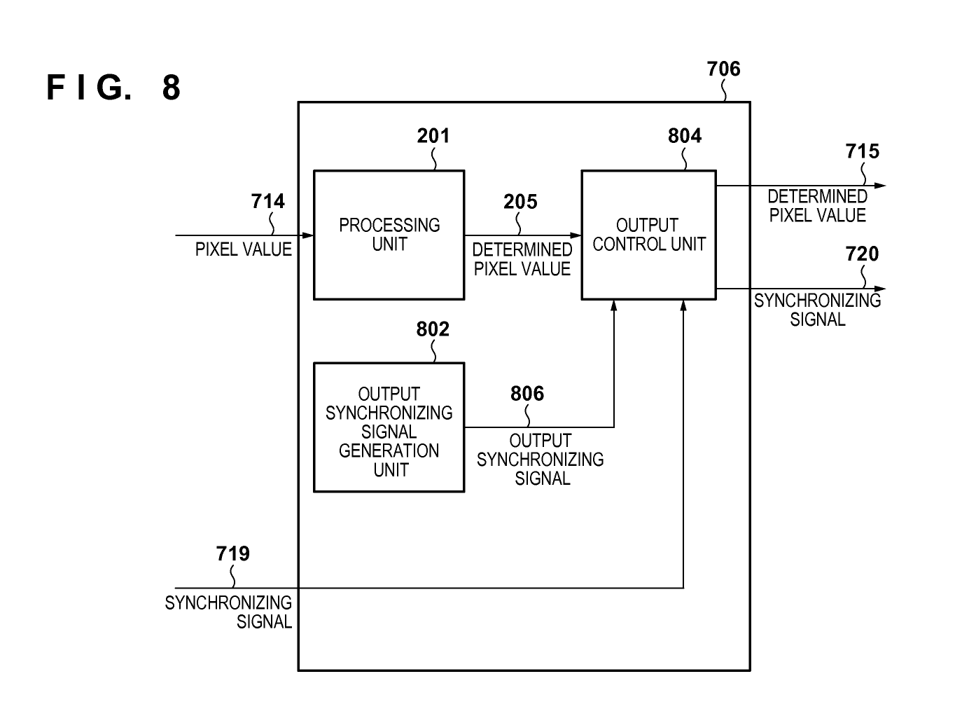

FIG. 8 illustrates an example of the functional configuration of the image processing circuit 706 according to this embodiment. The configuration shown in FIG. 8 is not limited to the image processing circuit 706, and is common to the image processing circuits 702 to 706.

In this embodiment, an output synchronizing signal generation unit 802 detects an output timing, and an output control unit 804 detects an input timing. The output control unit 804 waits until “the pixel value of an input pixel of interest in a band of interest is input to a processing unit 201” based on the detected output timing and input timing, and then controls to “output the pixel value of an output pixel of interest in the band of interest to the succeeding stage”. Operations by the output synchronizing signal generation unit 802 and output control unit 804 will be described in detail below.

The output synchronizing signal generation unit 802 will be described first. The output synchronizing signal generation unit 802 determines whether the determined pixel value sent by the processing unit 201 is the pixel value of a pixel (output pixel of interest) determined in advance to be synchronized between pixel values to be output for a band of interest. Note that an output pixel of interest in one of a plurality of stages corresponds to an input pixel of interest in the next stage. If the output synchronizing signal generation unit 802 determines that “the determined pixel value sent by the processing unit 201 is the pixel value of an output pixel of interest in a band of interest”, it sets an output synchronizing signal 806 to “1” indicating a valid value, and sends the output synchronizing signal 806 to the output control unit 804; otherwise, it sets the output synchronizing signal 806 to “0” indicating an invalid value, and sends the output synchronizing signal 806 to the output control unit 804. This determination as to whether the determined pixel value is an output pixel of interest can be done by counting the number of determined pixel values output from the processing unit 201, and determining whether the count value has reached a predetermined number corresponding to the output pixel of interest.

For example, the processing unit 201 resets a counter to zero before the start of processing for a band of interest, and increments the counter value by one every time a determined pixel value is output from the processing unit 201. If the counter value has reached “a predetermined number corresponding to an output pixel of interest”, the output synchronizing signal generation unit 802 determines that “the processing unit 201 has output the pixel value of the output pixel of interest”. A method of determining whether the processing unit 201 has output a pixel value determined in advance to be synchronized is not limited to a specific method as described above, as a matter of course.

The output control unit 804 will be described next. The output control unit 804 sends intact a determined pixel value 205 from the processing unit 201 to the succeeding stage as a determined pixel value 715. The output control unit 804 continues this sending operation until it receives a valid (=“1”) output synchronizing signal 806 from the output synchronizing signal generation unit 802. When the output control unit 804 receives a valid output synchronizing signal 806 from the output synchronizing signal generation unit 802, it temporarily stops sending the determined pixel value 715. At this moment, the output control unit 804 has sent the determined pixel value 205 output from the processing unit 201 before an output pixel of interest in a band of interest, but has not yet sent the output pixel of interest. The output control unit 804 determines whether the synchronizing signal 719 input from the preceding block is “1” indicating a valid value at this moment. If the output control unit 804 determines that the synchronizing signal 719 is valid at this moment, it sends the pixel value of the output pixel of interest to the succeeding block as the determined pixel value 715. On the other hand, if the output control unit 804 determines that the synchronizing signal 719 is invalid at this moment, it holds the pixel value of the output pixel of interest until it receives a valid synchronizing signal 719.

That is, if the pixel value to be output from the output control unit 804 to the succeeding stage is that of an output pixel of interest, the output control unit 804 stands by to output the pixel value of the output pixel of interest until the pixel value of an input pixel of interest is input as the pixel value 714 in the preceding stage. The output control unit 804 enables output of the pixel value of the output pixel of interest on standby after the pixel value of an input pixel of interest is input. This standby/enabling may be controlled by the output control unit 804 or a control unit (not shown).

In sending the pixel value of an output pixel of interest to the succeeding stage as the determined pixel value 715, the output control unit 804 sets the synchronizing signal 720 to “1” indicating a valid value, and sends it to the succeeding block.

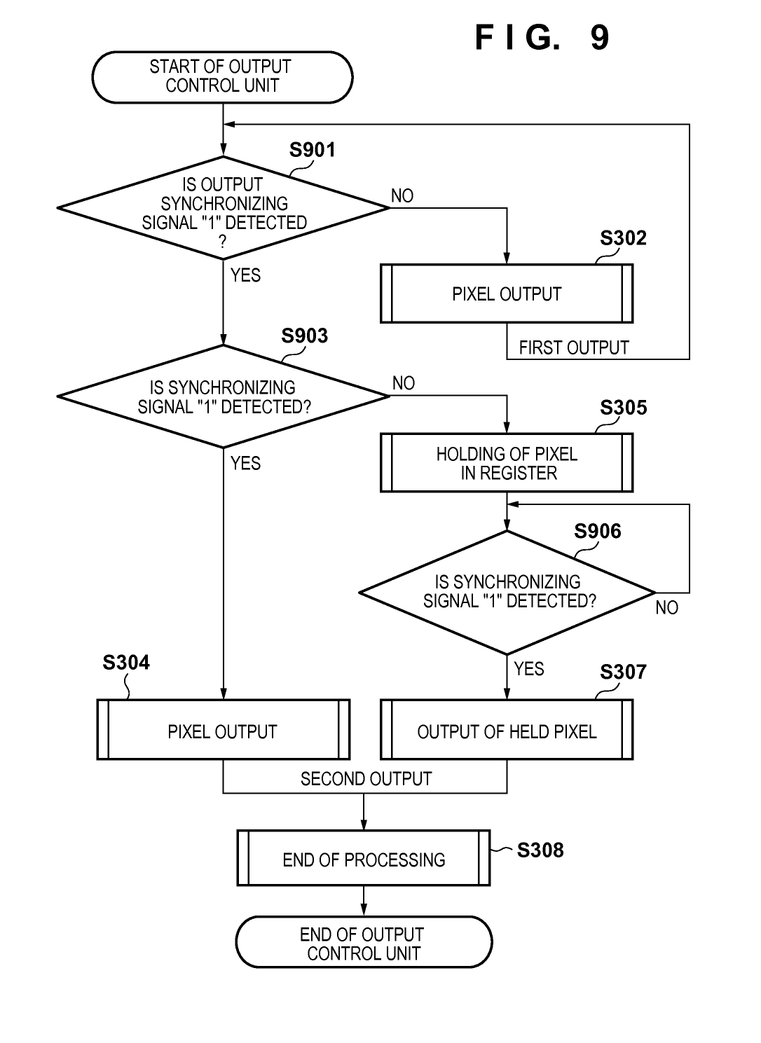

Processing by the output control unit 804 will be described below with reference to FIG. 9. The same reference numerals as in the processing shown in FIG. 3 denote steps in which the same details are implemented in the processing shown in FIG. 9, and a detailed description thereof will not be given.

In step S901, the output control unit 804 determines whether it has received a valid output synchronizing signal 806 from the output synchronizing signal generation unit 802. If NO is determined in step S901, the process advances to step S302; otherwise, the process advances to step S903.

In step S903, the output control unit 804 determines whether it has received a valid synchronizing signal 719 from the preceding block. If NO is determined in step S903, the process advances to step S305; otherwise, the process advances to step S304.

In step S906, the output control unit 804 determines whether it has received a valid synchronizing signal 719 from the preceding block. If NO is determined in step S906, the process returns to step S906; otherwise, the process advances to step S307.

As described above, according to this embodiment, it is possible to synchronize input/output of even an intermediate region (pixel) in a band between the circuits in the image processing unit, thereby continuously performing image processing without a malfunction. This allows appropriate processing and measurement for a specific region in a band (for example, histogram generation in the specific region and the time taken to process a specific pixel and pixels next to it). Also, by varying the count value for determining an output pixel across individual stages, image processing may include scaling processing and trimming processing to synchronously control input/output between the circuits in the image processing unit.

In another embodiment, a synchronizing signal is added to partial image data and transferred to the succeeding block as a data packet in this embodiment.

The data packet includes a data field to be transmitted and a side band signal field (user field) freely defined by the user for extension, as shown in, for example, FIG. 10B. A field 1001 stores data to be processed. A field 1010 stores the information of a side band signal freely defined by the user for extension.

The case wherein a synchronizing signal is stored in the user field will be described in this embodiment. FIG. 10C is a view of a data packet when a synchronizing signal is stored in the user field. The field 1001 stores data to be processed. A field 1003 stores a synchronizing signal.

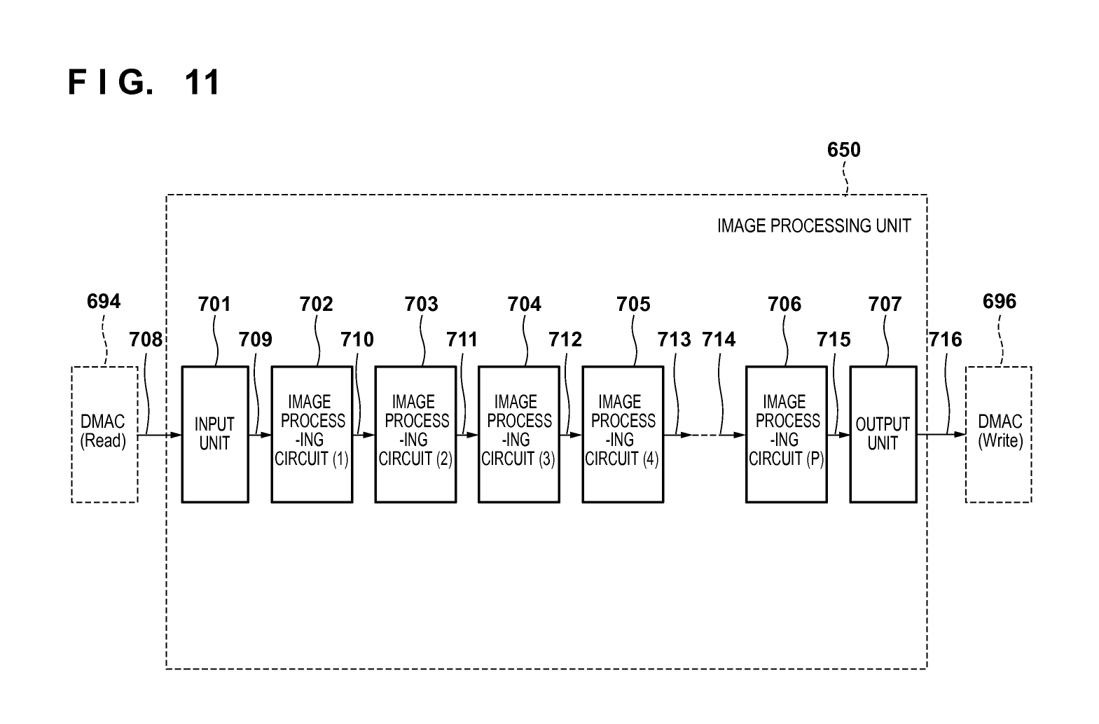

FIG. 11 shows the configuration of an image processing unit in this case. In this embodiment, an image processing circuit adds a synchronizing signal to partial image data and transmits it to a succeeding block as a data packet, as shown in FIG. 10C. The configuration of the image processing unit shown in FIG. 11 obviates the need for a signal line to transmit a synchronizing signal between individual image processing circuits, unlike that shown in FIG. 7A.

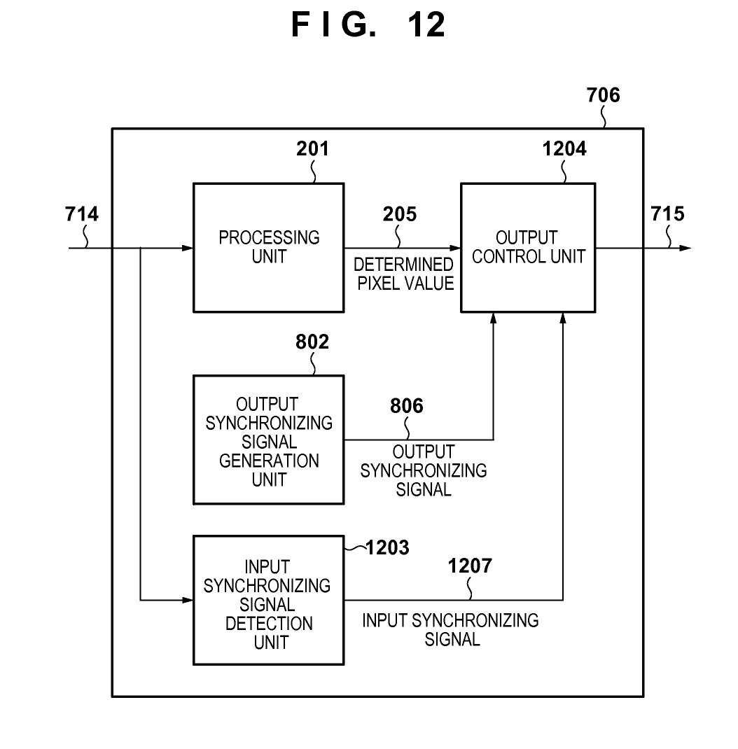

Also, FIG. 12 shows the configuration of the image processing circuit in this case. The configuration of the image processing circuit shown in FIG. 12 will be described below. The same reference numerals as in the configurations shown in FIG. 8 denote configurations which implement the same functions in FIG. 12, and a description thereof will not be given.

The operation of an input synchronizing signal detection unit 1203 will be described first. If partial image data stored in a data packet (714) input from the preceding stage to a processing unit 201 includes an input pixel of interest, the input synchronizing signal detection unit 1203 sets an input synchronizing signal 1207 to “1” indicating a valid value, and sends it to an output control unit 1204.

On the other hand, if partial image data stored in a data packet (714) input from the preceding stage to the processing unit 201 includes no input pixel of interest, the input synchronizing signal detection unit 1203 sets the input synchronizing signal 1207 to “0” indicating an invalid value, and sends it to the output control unit 1204. Information corresponding to the input synchronizing signal 1207 (a synchronization flag corresponding to an output synchronizing signal in the preceding stage) need only be added to an output pixel of interest in the preceding block, so it can efficiently be detected that the data packet includes an input pixel of interest. The operation of the output control unit 1204 will be described next.

The output control unit 1204 sends intact a determined pixel value 205 sent from the processing unit 201 to the succeeding block as a determined pixel value 715. The output control unit 1204 continues this sending operation until an output synchronizing signal 806 from an output synchronizing signal generation unit 802 changes to a valid value (=1). When the output synchronizing signal 806 from the output synchronizing signal generation unit 802 changes to a valid value (=1), the output control unit 1204 temporarily stops this sending operation. At this moment, the output control unit 1204 has sent intact, to the succeeding stage as the determined pixel value 715, the determined pixel value 205 output from the processing unit 201 before an output pixel of interest, but has not yet sent the pixel value of the output pixel of interest to the succeeding stage.

The output control unit 1204 determines whether the input synchronizing signal 1207 from the input synchronizing signal detection unit 1203 has a valid value (=1). If the output control unit 1204 determines that it has received a valid value (=1) as the input synchronizing signal 1207 at this moment, it sends a data packet (715) including an output pixel of interest to the succeeding block. On the other hand, if the output control unit 1204 determines that the input synchronizing signal 1207 is not a valid value (=1), it holds a data packet (715) including an output pixel of interest until the input synchronizing signal 1207 changes to a valid value (=1). When the output control unit 1204 receives a valid input synchronizing signal 1207, it sends the data packet (715) including the output pixel of interest and a synchronization signal (indicating that the synchronizing signal (field 1003) is “1”) to the succeeding block.

That is, when the data packet to be output next includes an output pixel of interest, the output control unit 1204 stands by to output the data packet including the output pixel of interest until a data packet including a synchronization flag is input.

The output control unit 1204 enables output of the data packet including the output pixel of interest after a data packet including a synchronization flag is input. This standby/enabling may be controlled by the output control unit 1204 or a control unit (not shown).

The synchronizing signal in this embodiment is also implemented as a signal as shown in FIG. 10D. le (line end) 1004 is a signal indicating that the data (field 1001) is the last pixel of one line. is (line start) 1005 is a signal indicating that the data (field 1001) is the first pixel of one line. be (band end) 1006 is a signal indicating that the data (field 1001) is the last pixel of one band. bs (band start) 1007 is a signal indicating that the data (field 1001) is the first pixel of one band. pe (page end) 1008 is a signal indicating that the data (field 1001) is the last pixel of one page. ps (page start) 1009 is a signal indicating that the data (field 1001) is the first pixel of one page. Note that each page includes a plurality of bands, and each band includes a plurality of lines.

By setting a synchronizing signal and controlling data output using the image processing circuit based on each synchronizing signal in this way, input/output of data between the image processing circuits can be synchronized at each position (le, ls, bs, be, ps, and pe) in one page.

Note that this embodiment is also applicable to a mode in which a plurality of image processing modules are connected to each other via a ring bus. The ring bus can commonly circulate a command packet and a data packet in one direction. The command packet serves to send parameters which define the details of image processing of each image processing module.

In another embodiment, the case wherein a synchronizing signal is transferred between a plurality of image processing units via a side band signal line will also be described. FIG. 7B is a block diagram showing the schematic configuration of an image processing apparatus when a synchronizing signal is transferred between a plurality of image processing units via a side band signal line. The same reference numerals as in the configurations shown in FIG. 6 denote configurations which implement the same functions in FIG. 7B, and a description thereof will not be given.

A CPU 602 controls a DMAC 694 to read a digital image signal stored in a RAM 606 and input it to an image processing unit 721. The CPU 602 stores the digital image signal having undergone predetermined image processing by the image processing unit 721 in the RAM 606 again using a DMAC 696, the write operation of which is set in advance.

The CPU 602 controls a DMAC 722 to read the digital image signal stored in the RAM 606 and input it to an image processing unit 723. The CPU 602 stores the digital image signal having undergone predetermined image processing by the image processing unit 723 in the RAM 606 again using a DMAC 724, the write operation of which is set in advance.

In outputting an output pixel of interest, the image processing unit 721 sends synchronizing signal “1” indicating the output pixel of interest to the image processing unit 723 as a side band signal 725.

When the pixel value to be output next is an output pixel of interest, the image processing unit 723 stands by to output this pixel value until it receives synchronizing signal “1” from the image processing unit 721. Upon receiving synchronizing signal “1”, the image processing unit 723 enables output of the output pixel of interest on standby.

In this manner, each image processing unit controls data output based on a synchronizing signal, so data input/output between a plurality of image processing units can be synchronized even when a synchronizing signal is transferred between the plurality of image processing units via a side band signal line.

Also, although positive logic (high-active logic) has been described in the above-mentioned embodiments, the present disclosure is also applicable to negative logic (low-active logic), as a matter of course.

Aspects of the present disclosure can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-211599 filed Sep. 27, 2011 and 2012-106312 filed May 7, 2012 which are hereby incorporated by reference herein in their entirety.

What is claimed is:

1. An image processing apparatus comprising:
an input unit that sequentially inputs pixel data included in partial image data;
a processing unit that processes the pixel data input from said input unit, and outputs the processed pixel data; and
an output control unit that outputs output pixel of interest data, which serves for synchronization with a latter block, of the processed pixel data as said input unit inputs input pixel of interest data included in the partial image data to said processing unit.

2. The apparatus according to claim 1, wherein
the partial image data is a band image obtained by dividing an image to be processed in a band shape,
the input pixel of interest data is the last pixel data, input to said input unit, of pixel data included in the band image input via said input unit, and
the output pixel of interest data is the last output pixel data of processed pixel data output for the band image from said processing unit.

3. The apparatus according to claim 1, wherein
the input pixel of interest data is the last pixel data, input to said input unit, of pixel data included in partial image data input via said input unit, and
the output pixel of interest data is the last output pixel data of processed pixel data output for the partial image data from said processing unit.

4. The apparatus according to claim 1, wherein
the input pixel of interest data is pixel data, which serves to identify one of a specific region and a specific pixel, of pixel data included in partial image data input via said input unit, and
the output pixel of interest data is pixel data, which serves to identify one of a specific region and a specific pixel, of processed pixel data output for the partial image data from said processing unit.

5. The apparatus according to claim 1, wherein said processing unit performs image processing which uses different numbers of input pixels and output pixels.

6. The apparatus according to claim 1, wherein in outputting the output pixel of interest data, said output control unit outputs a synchronizing signal indicating that the output pixel of interest data has been output.

7. The apparatus according to claim 6, wherein the synchronizing signal is transmitted using a side band signal.

8. The apparatus according to claim 1, wherein said input unit sequentially inputs data packets which store a plurality of pixel data included in partial image data, and said output control unit outputs a data packet including output pixel of interest data, which serves for synchronization with a latter block, of pixel data processed by said processing unit, as said input unit inputs a data packet including the input pixel of interest data.

9. The apparatus according to claim 8, wherein said output control unit stores, in the data packet including the output pixel of interest data, a flag indicating that the output pixel of interest data is to be included, and outputs the data packet.

10. The apparatus according to claim 1, wherein
said output control unit comprises a holding unit that holds the pixel data processed by said processing unit, and
a two-line handshake with the latter block is performed until the output pixel of interest data is held in said holding unit, and a valid signal to be sent to the latter block is invalidated after the output pixel of interest data is held in said holding unit.

11. The apparatus according to claim 1, wherein said processing unit performs trimming processing.

12. The apparatus according to claim 1, wherein said processing unit performs filter processing.

13. The apparatus according to claim 1, wherein said processing unit performs scaling processing.

14. The apparatus according to claim 1, further comprising:
an output unit serving as the latter block, that receives and outputs the output pixel of interest data from said output control unit; and
a processor that controls said input unit to input pixel data included in the next partial image data as said output unit receives the output pixel of interest data.

15. An image processing apparatus comprising:
an input unit that reads out for each specific unit region an image to be processed, and sequentially inputs pixels in the readout unit regions; and
an image processing unit that processes an image in a unit region of interest using a pixel value of at least one pixel input via said input unit from the unit region of interest to determine a pixel value of each pixel in the image in the unit region of interest, and sequentially outputs the determined pixel values to a specific output destination,
said image processing unit comprising:
a processing unit that processes an input pixel value and determines the processed pixel value;
a determination unit that determines whether the pixel value determined by said processing unit is a pixel value of a pixel of interest to be output for the unit region of interest; and
a control unit that, when said determination unit determines that the pixel value determined by said processing unit is the pixel value of the pixel of interest to be output for the unit region of interest, stands by to output the determined pixel value until said input unit inputs all pixels in the unit region of interest, and enables output of the determined pixel value on standby after said input unit inputs all the pixels in the unit region of interest.

16. The apparatus according to claim 15, wherein the specific output destination outputs the pixel value output from said image processing unit to an external equipment, and then issues an instruction to said input unit to read out an image in a unit region subsequent to the unit region of interest.

17. A method of controlling an image processing apparatus including an input unit that sequentially inputs pixel data included in partial image data, and a processing unit that processes the pixel data input from the input unit, and outputs the processed pixel data, comprising:
outputting output pixel of interest data, which serves for synchronization with a latter block, of the processed pixel data as the input unit inputs input pixel of interest data included in the partial image data to the processing unit.

18. An image processing method executed by an image processing apparatus, comprising:
an input step of reading out for each specific unit region an image to be processed, and sequentially inputting pixels in the readout unit regions; and
an image processing step of processing an image in a unit region of interest using a pixel value of at least one pixel input in the input step from the unit region of interest to determine a pixel value of each pixel in the image in the unit region of interest, and sequentially outputting the determined pixel values to a specific output destination,
the image processing step comprising:
a processing step of processing an input pixel value and determining the processed pixel value;
a determination step of determining whether the pixel value determined in the processing step is a pixel value of a pixel of interest to be output for the unit region of interest; and
a control step of, when it is determined in the determination step that the pixel value determined in the processing step is the pixel value of the pixel of interest to be output for the unit region of interest, standing by to output the determined pixel value until all pixels in the unit region of interest are input in the input step, and enabling output of the determined pixel value on standby when all the pixels in the unit region of interest have been input in the input step.
